(19) United States
(12) Patent Application Publication
(10) Pub. No.: US 2025/0206192 A1
(43) Pub. Date: Jun. 26, 2025

(54) STRING OF ELECTRICAL MODULES FOR POWERING A ROTARY ELECTRIC MACHINE

(71) Applicant: Valeo eAutomotive Germany GmbH, Erlangen (DE)

(72) Inventors: David NIKOLIC, Cergy Pontoise (FR); Erwan NICOT, Cergy Pontoise (FR)

(73) Assignee: Valeo eAutomotive Germany GmbH, Erlangen (DE)

(21) Appl. No.: 18/989,363

(22) Filed: Dec. 20, 2024

(30) Foreign Application Priority Data
Dec. 21, 2023 (FR) FR2314948

(51) Int. Cl. B60L 58/22; B60L 58/20

(52) U.S. Cl. CPC B60L 58/22; B60L 58/20; B60L 2210/10

(57) ABSTRACT

String of modules for an electrical circuit including a first terminal and a second terminal. Each module includes a primary terminal and a secondary terminal, with the primary terminal being connected to the secondary terminal of another module and/or the secondary terminal being connected to the primary terminal of another module. An electrical energy storage unit and an H-switching bridge are provided. The bridge includes two switching arms having two controllable switches disposed on either side of a midpoint, each midpoint being connected to one of the terminals of the module, the electrical energy storage unit being disposed in a branch parallel to the switching arms. At least one module includes a DC/DC converter, including controllable switches, connected, to terminals of the electrical energy storage unit and to a tertiary terminal and to a quaternary terminal of the module. At least one DC/DC converter is an isolated and reversible converter.

The present application relates to a string of modules for a power supply circuit of a rotary electric machine for propelling a vehicle.

In a known example, notably from application U.S. Pat. No. 11,799,392 B2, such a string of modules comprises a first terminal and a second terminal, with each module comprising:
a primary terminal and a secondary terminal, with the primary terminal being connected to the secondary terminal of another module and/or the secondary terminal being connected to the primary terminal of another module;
an electrical energy storage unit;
an H-switching bridge, the bridge comprising two switching arms comprising two controllable switches disposed on either side of a midpoint, each midpoint being connected to one of the terminals of the module, the electrical energy storage unit being disposed in a branch parallel to the switching arms; and
at least one module comprising a DC/DC converter, comprising controllable switches, connected, on the one hand, to the terminals of the electrical energy storage unit and, on the other hand, to a tertiary terminal and to a quaternary terminal of the module.

It may be advisable for the switches within the modules to be smartly controlled in order to ensure that the discharging of the energy storage units is equitable between the various modules. A requirement exists for simplifying the balancing of the charge of the energy storage units within the modules.

A requirement also exists for providing a solution for powering the loads within the vehicle that require a greater amount of energy, for example, the air conditioning or cooling systems of the powertrain of the vehicle. These loads cannot be connected to the DC/DC converters of the modules because the nominal voltages of the electrical energy storage units within the modules are generally of the order of a few volts or a few tens of volts, for example, between 3 V and 60 V, whereas these loads can have a nominal voltage of several hundred volts, for example, 400 V, 800 V or even more than 1,000 V, with the voltage conversion between these two orders of magnitude of nominal voltages requiring an infrastructure that is too expensive and/or too energy-consuming for this circuit topology.

The aim of the invention is to address all or some of these requirements and it achieves this aim, according to one of the aspects thereof, by virtue of a string of modules for an electrical circuit comprising a first terminal and a second terminal, with each module comprising:
a primary terminal and a secondary terminal, with the primary terminal being connected to the secondary terminal of another module and/or the secondary terminal being connected to the primary terminal of another module;
an electrical energy storage unit;
an H-switching bridge, the bridge comprising two switching arms comprising two controllable switches disposed on either side of a midpoint, each midpoint being connected to one of the terminals of the module, the electrical energy storage unit being disposed in a branch parallel to the switching arms; and
at least one module comprising a DC/DC converter, comprising controllable switches, connected, on the one hand, to the terminals of the electrical energy storage unit and, on the other hand, to a tertiary terminal and to a quaternary terminal of the module;
characterized in that the DC/DC converter is an isolated and reversible converter.

An isolated and reversible DC/DC converter in a known manner is in the form of a circuit having a primary circuit and a secondary circuit, with the primary circuit and the secondary circuit having at least one controllable switch and a winding, with the windings of the primary and secondary circuits being coupled so as to form a transformer.

This isolated and reversible DC/DC converter allows, when several modules are directly connected together via their tertiary and quaternary terminals or through a DC power supply bus, energy to be transferred between these modules. More specifically, at least one module is capable of transferring energy to another module, with the DC/DC converters of these modules respectively discharging and charging their electrical energy storage unit.

In order carry out this reversible energy transfer, it has been known for control signals to be sent to the switches of the DC/DC converter, with these control signals comprising one or more variable parameters, for example, a frequency or a duty cycle.

According to the invention, the modules are disposed within the string such that their primary terminal is connected to the secondary terminal of another module and their secondary terminal is connected to the primary terminal of another module, with the exception of a module whose primary terminal is connected to the first terminal of the string and of a module whose secondary terminal is connected to the second terminal of the string.

All the modules in the string can comprise a DC/DC converter, with this converter being an isolated and reversible converter.

The first and second terminals of the string can define the sole output voltage of the string other than the voltages defined between the tertiary and quaternary terminals of one of the modules.

This means that there is no intermediate output terminal within the string, i.e., an output terminal connected to both the primary terminal of a first module and to the secondary terminal of another module of the string, with this primary terminal and this secondary terminal being connected together.

The electrical energy storage unit can have a nominal voltage ranging between 3 and 60 V. For example, the nominal voltage of the electrical energy storage unit can be 5, 12, 24 or 48 V.

The electrical energy storage unit can be a cell of a lithium-ion type cell battery.

The modules can comprise a two-way switching cell disposed between their primary terminal and their secondary terminal, with this switching cell comprising at least one controllable semiconductor switch.

The presence of this switching cell between the terminals of the modules allows redundancy to be achieved when intending to disconnect the energy storage unit of one of the modules from the rest of the string. Thus, if the switching cell of said module is faulty, the energy storage unit of this module can be disconnected by controlling the switches of the switching bridge, and if one or more switches of the switching bridge is/are faulty, the energy storage unit can be functionally disconnected from the rest of the string by controlling the switching cell between the terminals of the module. This redundancy can make a circuit using a string of modules as described more resistant to malfunctions, can extend its lifetime, and can meet a safety requirement for the vehicle user.

The switching cell between the primary terminal and the secondary terminal of the modules can comprise a two-way transistor, notably a four-quadrant GaN-based power transistor.

As a variant, the switching cell between the primary terminal and the secondary terminal of the modules can comprise two one-way transistors mounted in anti-parallel or anti-series, notably MOSFET transistors or bipolar transistors.

As a variant, the switching cell between the primary terminal and the secondary terminal of the modules can comprise a microelectromechanical system switch.

The switching cell between the primary terminal and the secondary terminal is different from a mechanical relay.

The switches of the switching bridge within the module and the switching cell can be of the same type.

The energy storage unit within the modules can be disposed in a branch devoid of switches. In other words, the electrical energy storage unit is mounted between two nodes of the electrical circuit of the module and is not in series between these two nodes with any switches.

A further aim of the invention, according to one of the aspects thereof, is an electrical circuit for powering a rotary electric machine for propelling a vehicle comprising:
a polyphase electric machine;
an input interface capable of being connected to a charging station;
a power supply bus intended to be connected to an electrical load;
a plurality of strings of electrical modules, with each string being as described above;
a system of switches allowing each string to be connected to the terminals of a phase of the electric machine or to the input interface; and
a control unit capable of controlling the switches within the electrical circuit.

The tertiary and quaternary terminals of all or some of the modules of the string are connected to the power supply bus.

The control unit can control the switches of the DC/DC converters such that at least one module transfers energy to at least one other module via the power supply bus, with the DC/DC converters of these modules respectively discharging and charging their energy storage unit.

To this end, it is understood that the control unit has means for generating control signals capable of controlling the exchange of energy between the modules of the strings of the electrical circuit. Notably, the control unit is capable of varying one or more parameters of these control signals, for example, a frequency or a duty cycle. In known examples, the control unit can comprise a pulse width modulated signal generator.

This energy transfer is advantageous because it can be carried out between modules disposed on the same string and/or on different string by virtue of their connection to the power supply bus.

The circuit can comprise a second power supply bus, which is intended to be connected to an electrical load with a nominal voltage that is higher than the nominal voltage of the load intended to be connected to the first power supply bus, and an additional string of modules, with all the modules of the additional string comprising a DC/DC converter, with this converter being an isolated and reversible converter connected via its terminals to the second power supply bus, with the tertiary and quaternary terminals of the modules of the additional string being connected to the first power supply bus.

The control unit can control the switches of the DC/DC converters such that the modules of the plurality of strings transfer energy to the modules of the additional string via the power supply bus, with the DC/DC converters of the modules of the plurality of string and the DC/DC converters of the modules of the additional string respectively discharging and charging their energy storage unit when a charging station applies a voltage to the input interface.

This energy transfer from the modules of the plurality of strings to the additional string allows the electrical energy storage units of the modules of the additional string to be charged when a charging station applies a voltage to the input interface of the circuit, even if the additional string is not directly connected to the terminals of the input interface.

The control unit can control the switches of the DC/DC converters such that the modules of the plurality of strings transfer energy to the modules of the additional string via the power supply bus, with the DC/DC converters of the modules of the plurality of strings and the DC/DC converters of the modules of the additional string respectively discharging and charging their energy storage unit when the electric machine operates as a generator.

This energy transfer from the modules of the plurality of strings to the additional string allows the electrical energy storage units of the modules of the additional string to be charged when the electric machine operates as a generator, even if the additional string is not directly connected to the phases of the electric machine.

The control unit can control the switches of the DC/DC converters such that the modules of the additional string transfer energy to the modules of the plurality of strings via the power supply bus, with the DC/DC converters of the modules of the plurality of strings and the DC/DC converters of the modules of the additional string respectively charging and discharging their energy storage unit, when the charge connected to the second power supply bus is below a predetermined threshold or zero.

The value of the threshold can correspond to a ratio between the energy consumed by the loads intended to be connected to the second power supply bus and the maximum energy that can be provided by the additional string, notably the threshold value can be equal to 10%.

This energy transfer from the modules of the additional string to the plurality of strings allows the electrical energy storage units of the plurality of strings to be charged when the loads connected to the second power supply bus consume a low amount of energy or are not activated, and consequently can extend the autonomy of the circuit.

Powering the additional power supply bus from the input interface or from the phases of the stator of the rotary electric machine can be exclusively carried out by transferring electrical energy via the first power supply bus.

The electrical energy storage units contained in the modules of the additional string can have a different chemical composition, size and/or nominal voltage compared with the electrical energy storage units contained in the modules of the plurality of strings.

The number of strings implemented in the plurality of strings can be greater than or equal to the number of phases of the rotary electric machine.

The switch system can allow each string of the plurality of strings to be connected to the terminals of a phase of the electric machine for which this string is intended. In other words, a given string can only be connected to a single phase of the stator of the electric machine.

The rotary electric machine is, for example, a synchronous machine, for example, a three-phase synchronous machine or a synchronous machine whose electrical stator winding defines a dual three-phase system. The electrical stator winding is formed, for example, by wires, or by conductive bars that are connected to one another.

Throughout the above, the rotor can be a claw-pole rotor. This rotor then comprises first and second interleaved pole wheels, the first pole wheel defining a series of claws with an overall trapezoidal shape, each claw extending axially towards the second pole wheel, the second pole wheel defining a series of claws with an overall trapezoidal shape, each claw extending axially towards the first pole wheel. With respect to the rotor, a permanent magnet can be accommodated between two circumferentially consecutive claws.

As a variant, the rotor can be a rotor other than a claw-pole rotor, for example, a rotor comprising a stack of laminations or even a squirrel-cage rotor.

When the rotary machine is a synchronous machine, it can have a wound rotor or a permanent magnet rotor.

The rotary electric machine can have a nominal electric power of 25 KW, 100 KW, 200 KW or more.

The control unit of the circuit can be a single control unit or can comprise a main control unit and a plurality of subsidiary control units, for example, one subsidiary control unit per string in the circuit and/or one subsidiary control unit per module.

The electrical circuit can be reversible, i.e., the switches within the circuit can be controlled so that the strings of modules provide an alternating voltage across the terminals of the input interface.

The invention will be better understood upon reading the following description of non-limiting embodiments thereof:

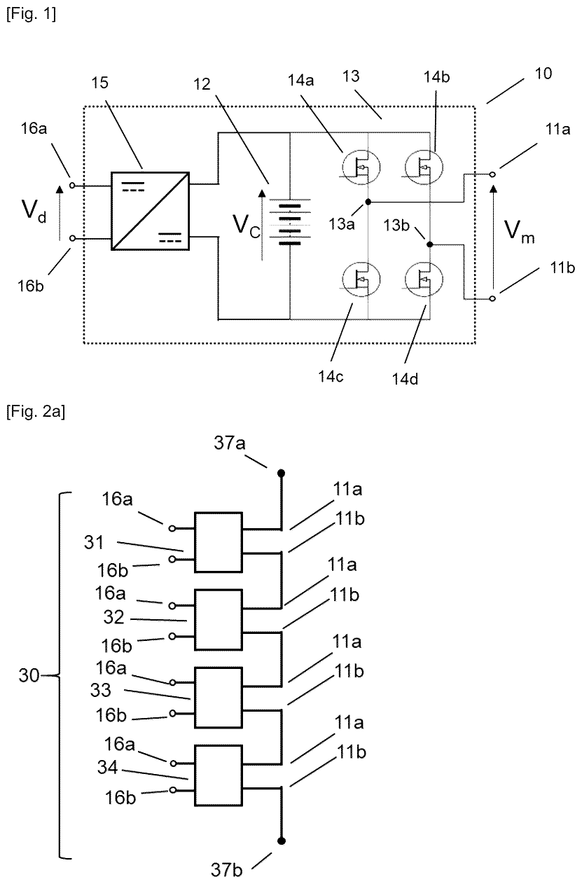

FIG. 1 shows a module intended to be implemented within a string of electrical modules of a circuit for powering a rotary electric machine;

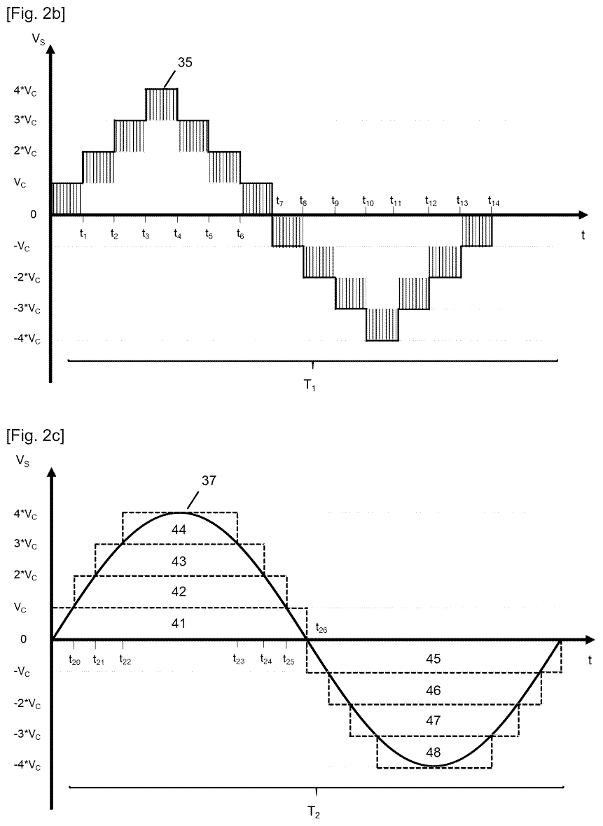

FIG. 2a shows a string of modules according to FIG. 1;

FIG. 2b shows an example of the output voltage of a string of modules according to FIG. 2a for powering an electric machine;

FIG. 2c shows an example of the input voltage of a string of modules according to FIG. 2a for charging the electrical energy storage units within the modules;

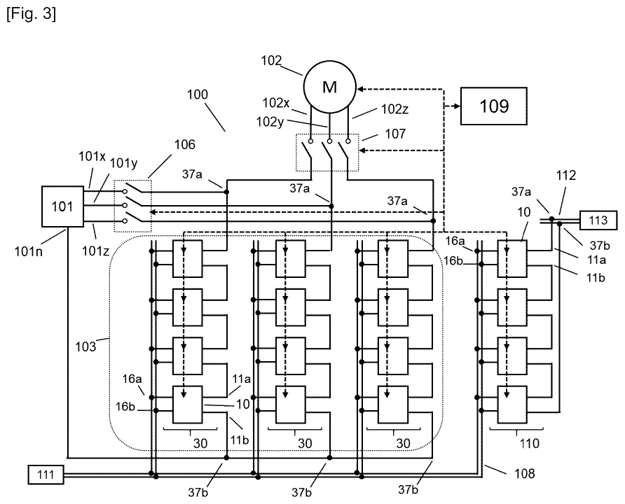

FIG. 3 shows a circuit for powering a rotary electric machine for propelling a vehicle, using a plurality of strings of modules according to FIG. 2a, and an additional string according to FIG. 2a for powering electrical loads.

FIG. 1 shows a module 10 intended to be implemented within a string of electrical modules of a circuit for powering a rotary electric machine.

The module 10 as shown in FIG. 1 comprises a primary terminal 11a and a secondary terminal 11b, with the voltage between the terminals 11a and 11b being denoted V_{M}.

The module 10 also comprises an electrical energy storage unit 12, with a nominal voltage V_{C}. This electrical energy storage unit can be a cell of a battery using a plurality of cells, and can have a nominal voltage ranging between 3 and 60 V, for example. This energy storage unit 22 is disposed in a branch parallel to a switching bridge 13, with this branch not including any switches. This switching bridge 13 is H-mounted and comprises controllable switches 14a, 14b, 14c, 14d disposed on either side of the midpoints 13a and 13b, with these midpoints being respectively connected to the primary terminal 11a and the secondary terminal 11b of the module 10. In the example shown in FIG. 1, the switches 14a, 14b, 14c and 14d are MOSFET transistors.

When a control unit controls the switches of the switching bridge 13 so that the switches 14a, 14d are in the open position and the switches 14b, 14c are in the closed position, the voltage Vₘ between the terminals 11a and 11b of the module 10 is equal to V_{C}. When the switches 14b, 14c are in the open position and the switches 14a, 14d are in the closed position, the voltage Vₘ between the terminals 11a and 11b of the module 10 is equal to −V_{C}.

When a control unit controls the switches of the switching bridge 13 so that the switches 14a, 14d are in the closed position and the switches 14b, 14c are in the open position, the voltage Vₘ between the terminals 11a and 11b of the module 10 is equal to V_{C}. When the switches 14b, 14c are in the closed position and the switches 14a, 14d are in the open position, the voltage Vₘ between the terminals 11a and 11b of the module 10 is equal to −V_{C}.

The module 10 also comprises a DC/DC converter 15, connected, on the one hand, to the terminals of the energy storage unit 12, and connected, on the other hand, to a tertiary terminal 16a and a quaternary terminal 16b of the module 10.

The DC/DC converter 15 can raise or lower the voltage V_{C} originating from the electrical energy storage unit 12.

The DC/DC converter 15 contains controllable switches, not shown in FIG. 1, so that it can be activated or deactivated by a command inside or outside the module 10. The DC/DC converter is also an isolated converter, which can use a transformer, notably a transformer comprising windings.

The DC/DC converter 15 is also reversible, in that it is capable of converting the voltage from the energy storage unit 12 to the tertiary 16a and quaternary 16b terminals, and vice versa. Thus, when a voltage source applies a DC voltage to the tertiary 16a and quaternary 16b terminals, the DC/DC converter can recharge the energy storage unit 12 of the module 10.

FIG. 2a shows a string 30 of four modules 31, 32, 33, 34. In this example, each module is identical to the module 10 in FIG. 1. The modules 31, 32, 33, 34 are linked together by their primary and secondary terminals between the two terminals 37a, 37b of the string. More specifically, the module 31 is connected to the first terminal 37a of the string 30 via its primary terminal and to the primary terminal of the module 32 via its secondary terminal, the module 32 is connected to the primary terminal of the module 33 via its secondary terminal, the module 33 is connected to the primary terminal of the module 34 via its secondary terminal and the module 34 is connected to the second terminal 37b of the string 30 via its secondary terminal.

The string 30 has a single output voltage that is defined between its two terminals 37a and 37b. Irrespective of the value that this output voltage can assume, it will be denoted Vₛ hereafter. In the example shown in FIG. 2, as the electrical energy storage units within the four modules 31, 32, 33, 34 are identical and have a nominal voltage V_{C}, the voltage Vₛ can assume any positive or negative integer multiple of V_{C} between −4*V_{C} and 4*V_{C} as its value when these electrical energy storage units are capable of supplying a voltage.

FIG. 2b shows a graph 35 depicting an example of the AC voltage Vₛ generated by the string of modules 30 depicted in FIG. 2a. This generated AC voltage Vₛ is capable of powering a rotary electric machine, it is periodic with a period T₁ and its shape is similar to a sine curve.

At the instants 0, t₁, t₂, and t₃, the modules 31, 32, 33, 34 of the string 30 are successively controlled so that the voltage between their terminals is equal to V_{C}, with the maximum voltage of the generated AC voltage Vₛ between two successive instants becoming equal to V_{C}, 2*V_{C}, 3*V_{C} and 4*V_{C}, respectively. Controlling a module is understood to mean controlling the switches within said module in order to obtain the desired voltage across its terminals.

At the instants t₄, t₅, t₆, the modules 31, 32, 33, 34 of the string 30 are successively controlled so that the voltage between their terminals is equal to 0, with the maximum voltage of the generated AC voltage 35 between two successive instants becoming equal to 3*V_{C}, 2*V_{C} and V_{C}, respectively.

The time interval between the instants 0 and t₇ corresponds to the positive part of the period T₁ of the AC voltage 35.

The order for controlling the modules 31, 32, 33, 34 between the instants 0 and t₇ can correspond, for example, to the state of charge of the electrical energy storage unit within the modules 31, 32, 33, 34. In order to balance the state of charge of the energy storage units contained in the modules 31, 32, 33, 34, the modules can be controlled, for example, at the instants 0, t₁, t₂, and t₃ in the decreasing order of the state of charge of their electrical energy storage unit and in the increasing order at the instants t₄, t₅, t₆ and t₇. Thus, the storage unit with the most charge from among the modules will be discharged for longer and the storage unit with the least charge will be discharged for less time, extending the autonomy of the string.

At the instants t₇, t₃, t₉, and t₁₀, the modules 31, 32, 33, 34 of the string 30 are successively controlled so that the voltage between their terminals is equal to −V_{C}, with the maximum voltage of the generated AC voltage 35 between two successive instants becoming equal to −V_{C}, −2*V_{C}, −3*V_{C} and −4*V_{C}, respectively. At the instants t₁, t₁₂, t₁₃, the modules 31, 32, 33, 34 of the string 30 are successively controlled so that the voltage between their terminals is equal to 0, with the maximum voltage of the generated AC voltage 35 between two successive instants becoming equal to −3*V_{C}, −2*V_{C} and V_{C}, respectively.

The time interval between the instants t₇ and t₁₄ corresponds to the negative part of the period T₁ of the AC voltage Vₛ.

The order for controlling the modules 31, 32, 33, 34 between the instants t₇ and t₁₃ can correspond, for example, to the state of charge of the electrical energy storage unit within the modules 31, 32, 33, 34, 35. In order to balance the state of charge of the energy storage units contained in the modules 31, 32, 33, 34, the modules can be controlled, for example, in the decreasing order of the state of charge of their electrical energy storage unit between the instants t₇, t₈, t₉, and t₁₀ and in the increasing order at the instants t₁₁, t₁₂, and t₁₃.

Between two successive instants, a module can be controlled so that the voltage between its terminals successively transitions from V_{C} to 0 and, vice versa, during the positive part of the period T₁ or −V_{C} to 0 and, vice versa, during the negative part of the period T₁, for example, by pulse width modulation. This reduces the harmonic distortions in the generated AC voltage 35.

The time intervals between two successive instants 0, t₁, t₂, t₃, etc., can be all or partially identical.

FIG. 2b shows a graph 37 depicting an example of the charging of the energy storage units within the modules of the string 30 depicted in FIG. 2a when an AC voltage Vₛ is applied to the terminals of said string.

The voltage Vₛ shown in FIG. 2c is a sinusoidal AC voltage that can be applied to the terminals 37a, 37b of the string 30 of FIG. 2. In the depicted example, the voltage Vₛ has a maximum and a minimum voltage of 4*V_{C} and −4*V_{C}, respectively, and is periodic with a period T₂. This AC voltage can originate from a charging station connected to the terminals of the string 30.

In the example shown in FIG. 2c, during the time interval 41 between the instant 0 and the instant t₂₆, for the instants when the voltage Vₛ is zero one module of the string 30, for example, the module 31, is controlled so that the voltage across its terminals is equal to V_{C}. As a result, during the time interval 41 the electrical energy storage unit of the module 31 is charged. During the time interval 42 between the instant t₂₀ and the instant t₂₅, for the instants when the voltage 37 is equal to V_{C} another module in the string 30, for example, the module 32, is controlled so that the voltage across its terminals is equal to V_{C}. As a result, during the time interval 42 the electrical energy storage unit of the module 32 is charged. During the time interval 43 between the instant t₂₁ and the instant t₂₄, for the instants when the voltage 37 is equal to 2*V_{C} another module in the string 30, for example, the module 33, is controlled so that the voltage across its terminals is equal to V_{C}. As a result, during the time interval 43 the electrical energy storage unit of the module 33 is charged. During the time interval 44 between the instant t₂₂ and the instant t₂₃, for the instants when the voltage 37 is equal to 3*V_{C} another module in the string 30, for example, the module 34, is controlled so that the voltage across its terminals is equal to V_{C}. As a result, during the time interval 44 the electrical energy storage unit of the module 34 is charged.

Similarly, during the time intervals 45, 46, 47 and 48, during the negative half-period of the period 38 of the AC voltage Vₛ, the modules 31, 32, 33, 34 of the string 30 are successively controlled so that the voltage between their primary and secondary terminals is equal to −V_{C} between the instants when the AC voltage Vₛ is equal to 0, −V_{C}, −2*V_{C} and −3*V_{C}, respectively, so that their respective electrical energy storage unit is charged during these respective time intervals.

The order for controlling the modules 31, 32, 33, 34 can correspond, for example, to the state of charge of the electrical energy storage unit within the modules 31, 32, 33, 34. In order to balance the state of charge of the electrical energy storage units contained in the modules 31, 32, 33, 34, the modules can be charged, for example, during the intervals 41, 42, 43, 44, respectively, according to the increasing order of the state of charge of their electrical energy storage unit. Thus, the most discharged electrical energy storage unit will be charged for longer, and vice versa. This ascending order can be similarly applied for the intervals 45, 46, 47, 48. Balancing the recharging between the electrical energy storage units reduces the overall recharging time of the string 30.

Between two successive instants, a module can be controlled so that the voltage between its terminals successively transitions from V_{C} to 0 and, vice versa, during the positive part of the period 38 or −V_{C} to 0 and, vice versa, during the negative part of the period 36, for example, by pulse width modulation. This reduces the harmonic distortions when charging the electrical energy storage unit.

FIG. 3 shows a circuit 100 intended to be integrated within an electrically propelled vehicle, using strings 30 according to FIG. 2a.

The circuit 100 comprises an input interface 101. This input interface is intended to be connected, for example, to a charging station for an electrically propelled vehicle capable of supplying a single or polyphase AC electrical voltage or a DC voltage.

In the example shown in FIG. 3, the input interface 101 comprises three terminals 101x, 101y, 101z capable of being connected to a respective phase of a three-phase AC voltage. The interface 101 comprises an additional terminal 101n capable of being connected to the neutral of an AC voltage. When a vehicle charging station connected to the input interface supplies a DC voltage or a single-phase AC voltage, an interconnection circuit, not shown, disposed between this charging station and the input interface 101 of the circuit 100 allows the supplied voltage to be distributed over the three terminals 101x, 101y and 101z.

The circuit 100 comprises a rotary electric machine 102. In the example shown in FIG. 3, the electric machine 102 is a polyphase machine, comprising three phases, denoted 102x, 102y and 102z.

A control unit 109 is present in the circuit 100. The control unit 109 can be a processor or an integrated circuit, for example, an FPGA or an ASIC, comprising the means for implementing the functions for controlling the circuit 100 and for controlling the set of switches within the circuit 100.

The circuit 100 as shown comprises a plurality of strings 103 made up of three strings 30. These three strings are strings according to the string 30 shown in FIG. 2a and are made up of a plurality of electrical modules 10 according to FIG. 1. In this example, the strings 30 each comprise four modules 10 that are identical and are modules according to the module 10 shown in FIG. 1.

In the example shown in FIG. 3, all the tertiary 16a and quaternary 16b terminals of all the modules 10 of the plurality of strings 103 are connected parallel to a power supply bus 108. This power supply bus is itself connected to an interface 111, with this interface 111 being intended to be connected to an electrical load, having a nominal voltage ranging between 8 and 48 volts, for example, 12 V. This load can be low-voltage equipment of the vehicle using the circuit 100 of FIG. 3, for example, an on-board navigation system. The DC/DC converters within the modules 10 then raise or lower the voltage of the energy storage unit so that the voltage between the terminals 16a and 16b is equal to the nominal voltage of the electrical load.

The strings 30 of FIG. 3 can be connected to a respective phase 102x, 102y, 102z of the electric machine 102 by closing the switches of the plurality of switches 107.

When the strings 30 are connected to a respective phase 102x, 102y, 102z of the electric machine 102, the control unit 59 can control the switches of the plurality of strings 103 such that they each supply the phases 102x, 102y, 102z of the electric machine 102 with an alternating voltage. For example, this supplied voltage can be like the voltage 35 shown in FIG. 2b, the voltages generated by the strings 30 can be phase-shifted with each other by 120 degrees.

When the strings 30 are connected to a respective phase 102x, 102y, 102z of the electric machine 102, and the electric machine 102 generates an alternating voltage, for example, during regenerative braking, the control unit 109 can control the switches of the plurality of strings 103 so that the electrical energy storage units of the modules 10 can be recharged from this alternating voltage.

In the example shown in FIG. 3, the strings 30 can be connected to a respective terminal 101x, 101y, 101z of the input interface by closing the switches of the plurality of switches 106. When they are connected to the input interface, the strings are capable of receiving an AC or DC voltage supplied by a charging terminal connected to the input interface.

In the example shown in FIG. 3, the circuit 100 is reversible, i.e., the control unit can control the switches within the circuit so that the strings provide an AC voltage across the terminals of the input interface 101. For example, the strings can generate a voltage like the voltage 35 shown in FIG. 2, with the voltages generated by the strings 30 being able to be phase-shifted with each other by 120°.

The circuit 100 of FIG. 3 also comprises an additional string of modules 110, with the modules 10 of this string 110 being identical to each other and to the module 10 of FIG. 1.

In this example, the additional string 110 comprises four modules 10 disposed between its terminals. The energy storage units within the modules 10 of the additional string 110 can have a different chemical composition, size and/or nominal voltage compared with the electrical energy storage units contained in the modules 10 of the plurality of strings 103.

The terminals of the additional string 110 are connected parallel to an additional power supply bus 112. This additional power supply bus 112 is connected to an additional interface 113 that is intended to be connected to an electrical load with a nominal voltage of several hundred volts, for example, 400 V, 800 V or even more than 1,000 V. This load can be high-voltage equipment of the vehicle using the circuit 100 of FIG. 3, for example, a powertrain cooling system or an air-conditioning system.

Thus, the modules 10 of the additional string 110 can be controlled such that they supply a DC voltage that is able to supply the additional load intended to be connected to the additional interface 112.

The tertiary 16a and quaternary 16b terminals of the modules 10 of the additional string 110 are connected parallel to the power supply bus 108. This connection of the modules of the plurality of strings 103 and of the additional string 110 to the same power supply bus, coupled with the fact that the DC/DC converter within the modules 10 is reversible, allows energy to be transferred between several modules 10 within the plurality of strings 103 and/or the additional string 110.

In the circuit 100 shown in FIG. 3, the supply of power for the additional power supply bus 112 from the input interface 101 or from the phases 102x, 102y, 102z of the stator of the rotary electric machine 102 exclusively occurs by transferring electrical energy via the power supply bus 108.

In a first example, the energy transfer between several modules 10 can allow the state of charge of the electrical energy storage unit to be balanced between at least two modules 10, with at least one first module 10 discharging its electrical energy storage unit, and at least one second module 10 charging its electrical energy storage unit. This balancing of the state of charge of the electrical energy storage units by the power supply bus 108 is advantageous because it can be carried out between two modules of two different strings, and therefore extends the overall autonomy of the circuit 100.

In a second example, this energy transfer can be used to charge the electrical energy storage units of the modules 10 of the additional string 110 when a charging station connected to the input interface 101 supplies an AC or DC voltage. In this case, the modules 10 of the plurality of strings 103 transfer energy to the modules of the additional string 110. As the additional string of modules 110 is not connected to the terminals of the input interface 101, this energy transfer allows both the energy storage units of the plurality of strings 103 and the energy storage units of the additional string 110 to be charged.

In a third example, this energy transfer can be used to charge the electrical energy storage units of the modules 10 of the additional string 110 when the electric machine 102 is operating as a generator, for example, during regenerative braking. In this case, the modules 10 of the plurality of strings 103 transfer energy to the modules of the additional string 110. As the additional string of modules 110 is not connected to the terminals of the electric machine 102, this energy transfer allows both the energy storage units of the plurality of strings 103 and the energy storage units of the additional string 110 to be charged.

In a fourth example, this energy transfer can allow the energy storage units of the modules 10 of the plurality of strings 103 to be charged when the charge connected to the additional power supply bus 112 is below a predetermined threshold or zero. In this case, the modules 10 of the additional string 110 transfer energy to the modules of the plurality of strings 103. This allows the energy stored in the modules 10 of the additional string 110 to be used to recharge the energy storage units of the modules 10 of the plurality of strings 103 when the additional string 110 is hardly used by the loads connected to the power supply bus 112. The threshold value can correspond to a ratio between the energy consumed by the loads intended to be connected to the second power supply bus 112 and the maximum energy that can be supplied by the additional string 110, notably the threshold value can be equal to 10%. This results in an improvement in the overall autonomy of the circuit 100.

The invention is not limited to the description that has been provided with reference to the figures.

Only some of the modules 10 of the plurality of strings 103 of the circuit 100 can comprise a DC/DC converter, and only some of the modules 10 can comprise a reversible DC/DC converter.

The control unit 109 can comprise a main control unit and a plurality of subsidiary control units, for example, one subsidiary control unit per string 30 and 110, and one subsidiary control unit per module 10, with the functions for controlling the circuit and for controlling the switches within the circuit being distributed within the main and subsidiary control units.

All or some of the modules 10 in the circuit 100 can comprise a two-way switching cell disposed between their primary terminal 11a and their secondary terminal 11b, with this switching cell comprising at least one controllable semiconductor switch. This switching cell allows the energy storage unit 12 to be functionally disconnected from the terminals 11a 11b of a module 10 by being controlled in the closed position.

It is also possible to propose redundancy for disconnecting the energy storage unit 12 from a module 10 by controlling both the switching cell and the switches of the switching bridge 13 in the closed position. This redundancy makes a module more resistant to malfunctions, for example, to a short-circuit in a switch.

This switching cell can comprise a two-way transistor, for example, a four-quadrant Gallium Nitride (GaN) power transistor, or two one-way transistors mounted in anti-parallel or in anti-series, for example, MOSFET transistors or bipolar transistors, or an electromechanical system switch.

The switches of the switching bridge 13 within the module 10 and of the switching cell can be of the same type.

1. String of modules for an electrical circuit comprising a first terminal and a second terminal, each module comprising:
a primary terminal and a secondary terminal, with the primary terminal being connected to the secondary terminal of another module and/or the secondary terminal being connected to the primary terminal of another module;
an electrical energy storage unit;
an H-switching bridge, the bridge comprising two switching arms comprising two controllable switches disposed on either side of a midpoint, each midpoint being connected to one of the terminals of the module, the electrical energy storage unit being disposed in a branch parallel to the switching arms; and
at least one module comprising a DC/DC converter, comprising controllable switches, connected, on the one hand, to the terminals of the electrical energy storage unit and, on the other hand, to a tertiary terminal and to a quaternary terminal of the module;
wherein at least one DC/DC converter is an isolated and reversible converter.

2. String according to claim 1, with all the modules of the string comprising an isolated and reversible DC/DC converter.

3. String according to claim 1, with the first and second terminals defining the sole output voltage of the string other than the voltages defined between the tertiary and quaternary terminals of one of the modules.

4. String according to claim 1, with the electrical energy storage unit having a nominal voltage ranging between 3 and 60 V.

5. String according to claim 1, with all or some of the modules comprising a two-way switching cell disposed between their primary terminal and their secondary terminal, with this switching cell comprising at least one controllable semiconductor switch.

6. String according to claim 1, with the energy storage unit within the modules being disposed in a branch devoid of switches.

7. Electrical circuit for powering a rotary electric machine for propelling a vehicle, comprising:
a polyphase electric machine;
an input interface capable of being connected to a charging station;
a power supply bus intended to be connected to an electrical load;
a plurality of strings of electrical modules, with each string being a string according to claim 1;
a system of switches allowing each string to be connected to the terminals of a phase of the electric machine or to the input interface; and
a control unit capable of controlling the switches within the electrical circuit;
with the tertiary and quaternary terminals of all or some of the modules of the strings being connected to the power supply bus.

8. Circuit according to claim 7, with the control unit being capable of controlling the switches of the DC/DC converters such that at least one module transfers energy to at least one other module via the power supply bus, with the DC/DC converters of these modules respectively discharging and charging their energy storage unit.

9. Circuit according to claim 8, comprising a second power supply bus intended to be connected to an electrical load with a nominal voltage that is higher than the nominal voltage of the load intended to be connected to the first power supply bus and an additional string of modules with all the modules of the additional string comprising an isolated and reversible DC/DC converter, connected via its terminals to the second power supply bus, with the tertiary and quaternary terminals of the modules of the additional string being connected to the first power supply bus.

10. Circuit according to claim 9, with the control unit being capable of controlling the switches of the DC/DC converters such that the modules of the plurality of strings transfer energy to the modules of the additional string via the power supply bus, with the DC/DC converters of the modules of the plurality of strings and the DC/DC converters of the modules of the additional string respectively discharging and charging their energy storage unit when a charging station applies a voltage to the input interface.

11. Circuit according to claim 9, with the control unit being capable of controlling the switches of the DC/DC converters such that the modules of the plurality of strings transfer energy to the modules of the additional string via the power supply bus, with the DC/DC converters of the modules of the plurality of strings and the DC/DC converters of the modules of the additional string respectively discharging and charging their energy storage unit when the electric machine operates as a generator.

12. Circuit according to claim 9, with the control unit being capable of controlling the switches of the DC/DC converters such that the modules of the additional string transfer energy to the modules of the plurality of strings via the power supply bus, with the DC/DC converters of the modules of the plurality of strings and the DC/DC converters of the modules of the additional string respectively charging and discharging their energy storage unit when the charge connected to the second power supply bus is below a predetermined threshold or zero.

13. Circuit according to claim 7, with the electrical energy storage units contained in the modules of the additional string having a different chemical composition, size and/or nominal voltage compared with the electrical energy storage units contained in the modules of the plurality of strings.

14. Circuit according to claim 7, with the number of strings implemented in the plurality of strings being greater than or equal to the number of phases of the rotary electric machine.

15. Circuit according to claim 7, with the system of switches allowing each string of the plurality of strings to be connected to the terminals of a phase of the electric machine for which this string is intended.

16. String according to claim 2, with the first and second terminals defining the sole output voltage of the string other than the voltages defined between the tertiary and quaternary terminals of one of the modules.

17. String according to claim 2, with the electrical energy storage unit having a nominal voltage ranging between 3 and 60 V.

18. String according to claim 2, with all or some of the modules comprising a two-way switching cell disposed between their primary terminal and their secondary terminal, with this switching cell comprising at least one controllable semiconductor switch.

19. String according to claim 2, with the energy storage unit within the modules being disposed in a branch devoid of switches.

20. Electrical circuit for powering a rotary electric machine for propelling a vehicle, comprising:
a polyphase electric machine;
an input interface capable of being connected to a charging station;
a power supply bus intended to be connected to an electrical load;
a plurality of strings of electrical modules, with each string being a string according to claim 2;
a system of switches allowing each string to be connected to the terminals of a phase of the electric machine or to the input interface; and
a control unit capable of controlling the switches within the electrical circuit;
with the tertiary and quaternary terminals of all or some of the modules of the strings being connected to the power supply bus.
